(19) United States
(12) Patent Application Publication
(10) Pub. No.: US 2026/0286921 A1
(43) Pub. Date: Sep. 24, 2026

(54) SUPPRESSION SYSTEM

(71) Applicant: ISUZU MOTORS LIMITED, Yokohama-shi (JP)

(72) Inventor: Takeshi OKAMOTO, Fujisawa-shi (JP)

(21) Appl. No.: 19/459,290

(22) Filed: Jan. 26, 2026

(30) Foreign Application Priority Data
Mar. 21, 2025 (JP) 2025-046568

(51) Int. Cl. F02M 35/12; F02M 35/10

(52) U.S. Cl. CPC F02M 35/1222; F02M 35/10157; F02M 35/10236

(57) ABSTRACT

A suppression system includes an intake passage in an engine, a first sensor that is provided in the intake passage and detects a pressure of combustion gas, a tank that stores gas having a pressure lower than the pressure of the combustion gas, a first valve that is provided in a connection passage, which connects the intake passage and the tank, and switches between communication and disconnection between the intake passage and the tank, and a valve control unit that opens the first valve when a detected pressure increase rate of the combustion gas is equal to or greater than a threshold value.

### CROSS-REFERENCE TO RELATED APPLICATIONS

The present application claims priority to Japanese Patent Applications No. 2025-046568, filed on March 21, 2025, contents of which are incorporated herein by reference in their entirety.

### BACKGROUND OF THE INVENTION

The present disclosure relates to a suppression system for suppressing backflow of combustion gas.

A backfire is known in which an air-fuel mixture combusts in an intake passage of an engine and combustion gas flows backward into the intake passage. Japanese Unexamined Patent Application Publication No. 2024-039140 discloses a technique in which a backfire prevention device (a flame arrester) is provided in an intake passage between a throttle valve and an intake manifold to suppress backflow of combustion gas into the intake passage.

However, when a backfire prevention device is provided in an intake passage, the backfire prevention device acts as a resistance, resulting in a decrease in intake pressure.

### BRIEF SUMMARY OF THE INVENTION

The present disclosure focuses on this point, and an object thereof is to achieve both suppression of backflow of combustion gas into an intake passage and suppression of a decrease in intake pressure.

An aspect of the present disclosure provides a suppression system including an intake passage that supplies intake air to a combustion chamber of an engine, a sensor that is provided in the intake passage and detects a pressure of a first gas in the intake passage, a tank that stores a second gas having a pressure lower than atmospheric pressure, a connection passage that connects the intake passage and the tank upstream of the sensor in the intake passage, a valve that is provided in the connection passage and switches between communication and disconnection between the intake passage and the tank, and a valve control unit that opens the valve to allow the intake passage and the tank to communicate with each other when a pressure increase rate of the first gas detected by the sensor is equal to or greater than a threshold value.

### BRIEF DESCRIPTION OF THE DRAWINGS

FIG. 1 shows a configuration of a suppression system.

FIG. 2 illustrates a configuration of a cylinder of an engine.

FIG. 3 illustrates a flow of combustion gas.

FIG. 4 is a flowchart showing an example of a process of suppressing damage to a device.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Configuration of suppression system S

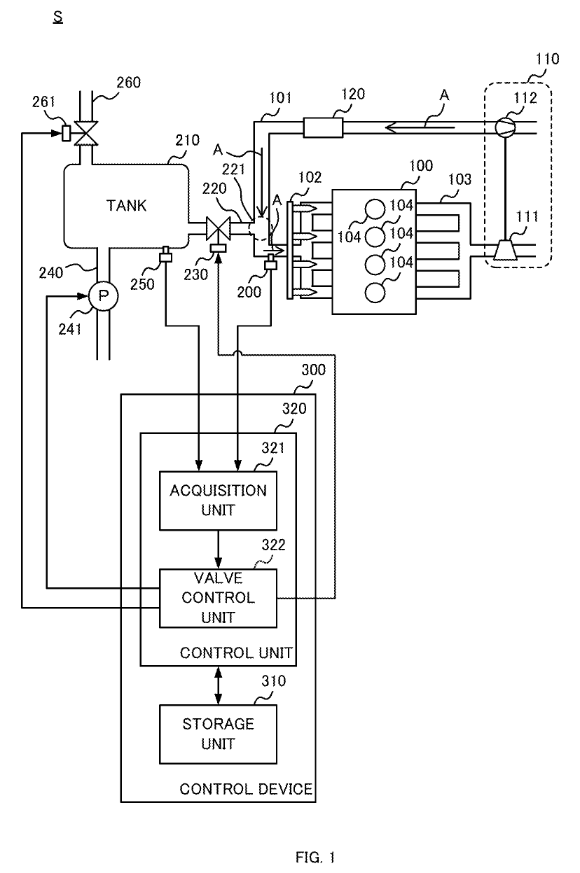

FIG. 1 shows a configuration of a suppression system S. The suppression system S is a system for suppressing damage to a device caused by a backfire in which an air-fuel mixture does not normally combust in a combustion chamber of an engine 100 and combustion gas flows backward into an intake passage 101. The suppression system S includes the engine 100, the intake passage 101, a fuel injection device 102, an exhaust passage 103, a supercharger 110, an intercooler 120, a first sensor 200, a tank 210, a connection passage 220, a first valve 230, a decompression passage 240, a pump 241, a second sensor 250, a discharge passage 260, a second valve 261, and a control device 300.

The engine 100 is an internal combustion engine that generates power by combusting and expanding a mixture of combustible gas and intake air. The combustible gas is hydrogen or natural gas, for example. The natural gas is a gas including methane, ethane, propane, and the like. It is assumed that the engine 100 of the present embodiment combusts hydrogen. The engine 100 is mounted on an automobile or a ship, for example.

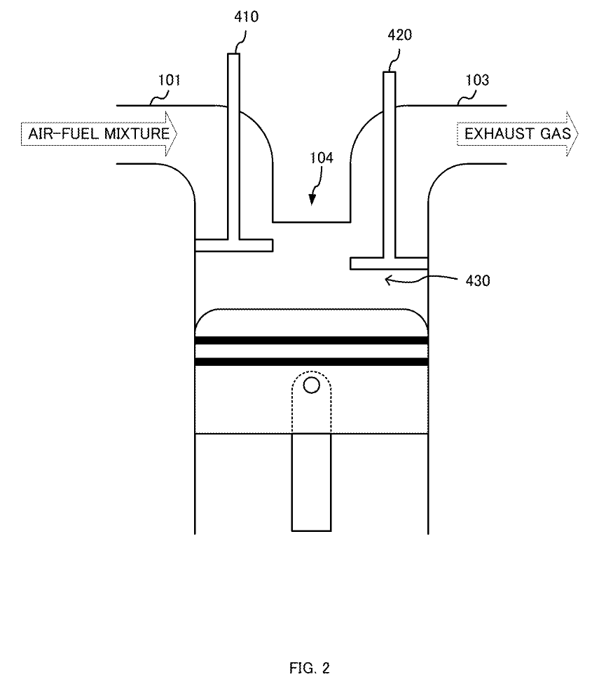

The engine 100 includes a plurality of cylinders 104. FIG. 2 illustrates a configuration of the cylinder 104 of the engine 100. The cylinder 104 of the engine 100 includes an intake valve 410 and an exhaust valve 420. The intake valve 410 opens when the air-fuel mixture is taken into a combustion chamber 430. The air-fuel mixture is mixed in the intake passage 101. The exhaust valve 420 opens when exhaust gas after combustion in the combustion chamber 430 is discharged from the combustion chamber 430. The intake valve 410 opens before the exhaust valve 420 closes. Specifically, the intake valve 410 opens before the exhaust valve 420 closes in an exhaust process of discharging the exhaust gas in the combustion chamber 430. More specifically, before the exhaust valve 420 closes in the exhaust process, the intake valve 410 opens with an opening degree smaller than a fully open opening degree of the intake valve 410. As described above, a period in which the exhaust valve 420 opens and a period in which the intake valve 410 opens partially overlap each other (so-called valve overlap).

The intake passage 101 is a passage that supplies intake air A to the combustion chamber 430 of the engine 100. The intake air A passes through the compressor 112 of the supercharger 110 and the intercooler 120 provided in the intake passage 101, and is supplied to each cylinder 104. The intercooler 120 cools the intake air A to be supplied to the engine 100. The intercooler 120 is a heat exchanger that cools intake air by exchanging heat between cooling water of the engine 100 or outside air and the intake air A.

The fuel injection device 102 supplies hydrogen to the intake passage 101. Specifically, the fuel injection device 102 injects hydrogen into a passage connecting each of the plurality of cylinders 104 of the engine 100 and the intake passage 101. As a result, a mixture of hydrogen and the intake air A is generated in a passage leading to the combustion chamber 430. In other words, the mixture of hydrogen and the intake air A is generated downstream of the fuel injection device 102 and upstream of the cylinder 104 in the intake passage 101.

The exhaust passage 103 is a passage for discharging exhaust gas of the engine 100 to the outside. A turbine 111 of the supercharger 110 is provided in the exhaust passage 103. The turbine 111 rotates as exhaust gas passes therethrough. The compressor 112 of the supercharger 110 is provided upstream of the intercooler 120 in the intake passage 101. The compressor 112 is coupled to the turbine 111. The compressor 112 supercharges intake air by rotating in conjunction with the rotation of the turbine 111.

The first sensor 200 is provided in the intake passage 101. The first sensor 200 is provided downstream of the intercooler 120 and upstream of the fuel injection device 102 in the intake passage 101. The first sensor 200 is a pressure sensor that detects pressure of a first gas flowing through the intake passage 101. The first gas is the intake air A flowing through the intake passage 101 or the combustion gas flowing backward from the combustion chamber 430 to the intake passage 101. The first sensor 200 measures pressure of gas with a pressure sensitive element via a diaphragm (stainless steel diaphragm, silicon diaphragm, or the like), converts the pressure into an electrical signal, and outputs the electrical signal. The first sensor 200 can measure pressure, for example, 72,000 times per second. The first sensor 200 detects pressure of the intake air A flowing through the intake passage 101 and pressure of the combustion gas flowing backward from the combustion chamber 430 to the intake passage 101.

The connection passage 220 connects the intake passage 101 and the tank 210. Specifically, the connection passage 220 connects the intake passage 101 and the tank 210 upstream of the first sensor 200 in the intake passage 101. More specifically, the connection passage 220 connects the intake passage 101 and the tank 210 at a connection point 221 upstream of the first sensor 200 and downstream of the intercooler 120 in the intake passage 101. The first valve 230 is provided in the connection passage 220. The first valve 230 switches between communication and disconnection between the intake passage 101 and the tank 210.

The tank 210 stores a second gas having pressure lower than the pressure of the intake air A, which is the first gas. The second gas is air, for example, but is not limited thereto. The tank 210 is a pressure-resistant container made of stainless steel, for example. The volume of the tank 210 is greater than the volume of the intake passage 101. Specifically, the volume of the tank 210 is twice the volume of the intake passage 101, but is not limited thereto.

The decompression passage 240 is connected to the tank 210. The decompression passage 240 connects the tank 210 and the outside of the tank 210. The pump 241 is provided in the decompression passage 240. The pump 241 causes the pressure of the second gas in the tank 210 to be less than atmospheric pressure by drawing the second gas from the tank 210. More specifically, the pump 241 causes the pressure of the second gas in the tank 210 to be equal to or lower than a predetermined pressure that is lower than the atmospheric pressure lower than a first pressure of the intake air A, which is the first gas. The predetermined pressure is 100 Pa, for example, but is not limited thereto.

The second sensor 250 is an internal pressure sensor provided in the tank 210. The second sensor 250 detects pressure of the second gas in the tank 210. The second sensor 250 is a sensor equivalent to the first sensor 200. In the following description, the pressure of the second gas in the tank 210 may be referred to as an internal pressure.

The discharge passage 260 is connected to the tank 210 at a position different from that of the decompression passage 240. The discharge passage 260 connects the inside of the tank 210 and the outside of the tank 210. The discharge passage 260 is a passage for discharging the second gas in the tank 210 to the outside. Specifically, the discharge passage 260 discharges the second gas in the tank 210 to the outside when the pressure of the second gas in the tank 210 becomes higher than a limit value of the tank 210. Details of the limit value of the tank 210 and a process of discharging the second gas to the outside will be described later. The second valve 261 is a discharge valve provided in the discharge passage 260. The second valve 261 switches between communication and disconnection between the inside of the tank 210 and the outside of the tank 210.

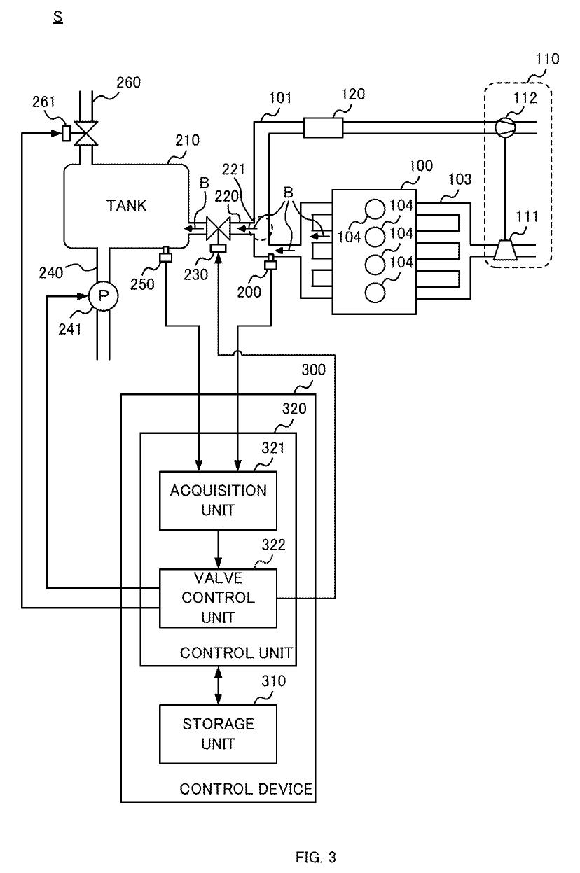

As described above, the period in which the exhaust valve 420 opens partially overlaps with the period in which the intake valve 410 opens. At this time, a high-temperature exhaust gas and the air-fuel mixture may come into contact with each other in the combustion chamber 430. In this case, a so-called backfire occurs in which the air-fuel mixture starts combustion and the combustion gas flows backward through the intake passage 101. FIG. 3 illustrates a flow of combustion gas B. In FIG. 3, the fuel injection device 102 is omitted in order to make the flow of the combustion gas B easy to see. As shown in FIG. 3, the combustion gas B flows backward from the cylinder 104 toward the upstream portion of the intake passage 101. When the combustion gas B reaches a device (for example, the intercooler 120) provided upstream in the intake passage 101, the device may be damaged.

Therefore, when a backfire occurs, the control device 300 opens the first valve 230 to allow the intake passage 101 and the tank 210 to communicate with each other. As described above, the pressure of the second gas in the tank 210 is lower than the atmospheric pressure lower than the pressure of the first gas flowing through the intake passage 101. Since the pressure of the second gas in the tank 210 is lower than the pressure of the first gas, the combustion gas B flowing backward in the intake passage 101 does not flow toward the upstream portion of the intake passage 101, and flows toward the tank 210 having a pressure lower than that of the intake passage 101. Thus, the control device 300 can store, in the tank 210, the combustion gas B flowing backward from the combustion chamber 430. In FIG. 3, the combustion gas B does not go to the intercooler 120 in the upstream portion of the intake passage 101, and passes through the connection passage 220 to reach the tank 210. In this manner, the suppression system S can store, in the tank 210, the combustion gas B flowing backward when a backfire occurs, thereby suppressing the combustion gas B from reaching the device in the upstream portion of the intake passage 101. Further, since it is not necessary to provide a backfire prevention device in the intake passage 101, there is no intake pressure loss in the intake passage 101. As described above, the suppression system S can achieve both suppression of the backflow of the combustion gas to the intake passage 101 and suppression of a decrease in intake pressure. A specific configuration of the control device 300 will be described below.

The control device 300 includes a storage unit 310 and a control unit 320. The storage unit 310 is a storage medium including a Read Only Memory (ROM), a Random Access Memory (RAM), a hard disk, and the like. The storage unit 310 stores a program executed by the control unit 320.

The control unit 320 is a calculation resource including a processor such as a Central Processing Unit (CPU). The control unit 320 implements functions as an acquisition unit 321 and a valve control unit 322 by executing the program stored in the storage unit 310.

The acquisition unit 321 acquires the pressure of the first gas detected by the first sensor 200. The acquisition unit 321 acquires an increase rate of the pressure of the first gas based on the acquired pressure. Specifically, the acquisition unit 321 acquires an increase rate of the pressure (hereinafter, referred to as a “pressure increase rate”) of the first gas detected in a predetermined time. The predetermined time is set to be shorter than a time taken for the combustion gas flowing backward to reach the connection point 221 from the cylinder 104, for example. A specific value of the predetermined time may be appropriately determined by experiments or the like. Further, the acquisition unit 321 acquires the internal pressure of the tank 210 detected by the second sensor 250.

The valve control unit 322 determines whether a backfire has occurred. When the combustion gas B flows backward through the intake passage 101, the pressure detected by the first sensor 200 rapidly increases, and the valve control unit 322 determines whether or not a backfire has occurred based on a pressure increase rate. Specifically, when the pressure increase rate is equal to or greater than a threshold value, the valve control unit 322 determines that a backfire has occurred. The threshold value is set to a value greater than the pressure increase rate of the intake air A by the supercharger 110, for example, but may be appropriately determined by experiments or the like. When the pressure increase rate is less than the threshold value, the valve control unit 322 determines that no backfire has occurred.

When a backfire has occurred, the valve control unit 322 opens the first valve 230. Specifically, when the pressure increase rate is equal to or greater than the threshold value and it is determined that a backfire has occurred, the valve control unit 322 opens the first valve 230 to allow the intake passage 101 and the tank 210 to communicate with each other. Since the pressure of the tank 210 is lower than the atmospheric pressure lower than the pressure of the combustion gas B, the combustion gas B is stored in the tank 210. As a result, the combustion gas B is suppressed from reaching the upstream of the intake passage 101. When no backfire has occurred, the valve control unit 322 maintains a closed state of the first valve 230.

The valve control unit 322 determines whether or not a backfire has been resolved. For example, the valve control unit 322 determines whether or not a backfire has been resolved based on whether or not a post-release pressure detected by the first sensor 200 after opening the first valve 230 is equal to or less than a predetermined reference value. The reference value is set to a value lower than the pressure of the combustion gas B. The reference value is the pressure of the intake air A pressurized by the supercharger 110, for example. When the post-release pressure is greater than the reference value, the valve control unit 322 determines that a backfire has not been resolved, and waits until the post-release pressure becomes equal to or less than the reference value. When the post-release pressure becomes equal to or less than the reference value, the valve control unit 322 determines that a backfire has been resolved.

When a backfire has been resolved, the valve control unit 322 closes the first valve 230 to disconnect the intake passage 101 and the tank 210 from each other. The valve control unit 322 starts the pump 241 after the intake passage 101 and the tank 210 are disconnected from each other. The valve control unit 322 causes the pump 241 to draw the second gas from the tank 210 by operating the pump 241 when the intake passage 101 and the tank 210 are disconnected from each other. In this case, the second gas stored in the tank 210 is a gas in which the combustion gas B flowing backward from the combustion chamber 430 and air are mixed. The valve control unit 322 causes the pump 241 to draw the second gas from the tank 210 until the internal pressure of the tank 210 becomes 100 Pa, for example. When the internal pressure of the tank 210 becomes 100 Pa, the valve control unit 322 stops the pump 241. In this way, the valve control unit 322 can lower the internal pressure of the tank 210 than the atmospheric pressure.

An amount of the combustion gas B flowing backward may be greater than the volume of the tank 210. In this case, there is a concern that the combustion gas B cannot be stored in the tank 210, and therefore reaches the device in the upstream portion of the intake passage 101.

Therefore, when the internal pressure of the tank 210 exceeds a predetermined value after the first valve 230 is released, the valve control unit 322 discharges the second gas in the tank 210 to the outside. Specifically, when the internal pressure detected by the second sensor 250 is equal to or higher than the limit value of the tank 210, the valve control unit 322 opens the second valve 261 to cause communication between the inside of the tank 210 and the outside of the tank 210. The limit value of the tank 210 is greater than the atmospheric pressure, for example. A specific value of the limit value of the tank 210 is determined according to a pressure resistance value of the tank 210. In this way, when an amount of the combustion gas B exceeding the capacity of the tank 210 is generated, the valve control unit 322 discharges the combustion gas B stored in the tank 210 to the outside of the tank 210, thereby suppressing the combustion gas B from reaching the device in the upstream portion of the intake passage 101.

### Modification

As a distance between the connection passage 220 and the intercooler 120 increases, the intercooler 120 is less likely to be affected by a backfire. Therefore, the connection passage 220 connects the intake passage 101 and the tank 210 at a position where a distance between the connection point 221 and the first sensor 200 in the intake passage 101 is shorter than the distance between the connection point 221 and the intercooler 120. Specifically, the distance between the connection point 221 and the first sensor 200 is equal to or less than one-half the distance between the connection point 221 and the intercooler 120. In this manner, even if a backfire occurs, it is possible to reduce the probability that the backfire reaches the intercooler 120.

### Process for suppressing damage

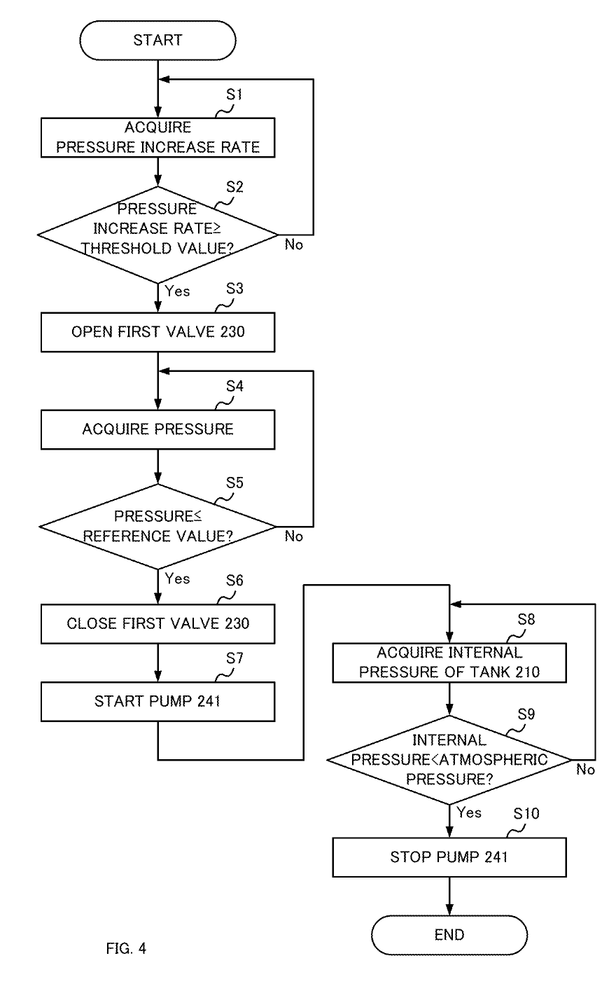

FIG. 4 is a flowchart showing an example of a process of suppressing damage to the device. The process of suppressing damage is appropriately executed while the engine 100 is operating.

The acquisition unit 321 acquires the pressure increase rate based on the pressure detected by the first sensor 200 (step S1). Specifically, the acquisition unit 321 acquires the pressure increase rate of the pressure detected by the first sensor 200 in the predetermined period.

The valve control unit 322 determines whether or not the pressure increase rate is equal to or greater than the threshold value (step S2). If the pressure increase rate is less than the threshold value (No in step S2), the valve control unit 322 waits until the pressure increase rate becomes equal to or greater than the threshold value. If the pressure increase rate is equal to or greater than the threshold value (Yes in step S2), the valve control unit 322 determines that a backfire has occurred, and opens the first valve 230 (step S3). The valve control unit 322 opens the first valve 230 to allow the intake passage 101 and the tank 210 to communicate with each other. Accordingly, since the combustion gas B flows to the tank 210 having a pressure lower than the pressure in the upstream portion of the intake passage 101, the valve control unit 322 can suppress the combustion gas B from reaching the device (for example, the intercooler 120) in the upstream portion of the intake passage 101.

The acquisition unit 321 acquires the pressure detected by the first sensor 200 after the valve control unit 322 opens the first valve 230 (step S4). The valve control unit 322 determines whether or not the acquired pressure is equal to or less than the reference value (step S5). If the acquired pressure is greater than the reference value (No in step S5), the valve control unit 322 waits until the acquired pressure becomes equal to or smaller than the reference value. If the acquired pressure is equal to or less than the reference value (Yes in step S5), the valve control unit 322 determines that a backfire has been resolved, and closes the first valve 230 (step S6). The valve control unit 322 closes the first valve 230 to disconnect the intake passage 101 and the tank 210 from each other. After disconnecting the intake passage 101 and the tank 210 from each other, the valve control unit 322 starts the pump 241 (step S7).

The acquisition unit 321 acquires the internal pressure of the tank 210 detected by the second sensor 250 after the start of the pump 241 (step S8). The valve control unit 322 determines whether or not the internal pressure of the tank 210 is less than the atmospheric pressure (step S9). If the internal pressure of the tank 210 is equal to or greater than the atmospheric pressure (No in step S9), the valve control unit 322 waits until the acquired pressure becomes lower than the atmospheric pressure. If the internal pressure of the tank 210 is less than the atmospheric pressure (Yes in step S9), the valve control unit 322 stops the pump 241 (step S10).

### Effects of suppression system S

As described above, the suppression system S includes i) the first sensor 200 that is provided in the intake passage 101 supplying the intake air A to the combustion chamber 430 of the engine 100 and detects the pressure of the first gas in the intake passage 101, ii) the tank 210 that stores the second gas having a pressure lower than the first gas, iii) the connection passage 220 that connects the intake passage 101 and the tank 210 upstream of the first sensor 200 in the intake passage 101, and iv) the first valve 230 that is provided in the connection passage 220 and switches between communication and disconnection between the intake passage 101 and the tank 210.

When the pressure increase rate of the first gas detected by the first sensor 200 becomes equal to or greater than the threshold value, the suppression system S opens the first valve 230 to allow the intake passage 101 and the tank 210 to communicate with each other, thereby introducing the combustion gas B flowing through the intake passage 101 into the tank 210. Accordingly, since flames and pressure waves of the combustion gas B flow into the tank 210, it is possible to suppress the combustion gas B from reaching the device (e.g., the intercooler 120) in the upstream portion of the intake passage 101. In addition, since a backfire prevention device (a flame arrestor) or the like is not provided in the intake passage 101, there is no intake pressure loss in the intake passage 101. As described above, the suppression system S can suppress the backflow of the combustion gas B and suppress the intake pressure loss.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A suppression system comprising:
an intake passage that supplies intake air to a combustion chamber of an engine;
a sensor that is provided in the intake passage and detects a pressure of a first gas in the intake passage;
a tank that stores a second gas having a pressure lower than atmospheric pressure;
a connection passage that connects the intake passage and the tank upstream of the sensor in the intake passage;
a valve that is provided in the connection passage and switches between communication and disconnection between the intake passage and the tank; and
a valve control unit that opens the valve to allow the intake passage and the tank to communicate with each other when a pressure increase rate of the first gas detected by the sensor is equal to or greater than a threshold value.

2. The suppression system according to claim 1, comprising:
a decompression passage that connects the tank and the outside of the tank; and
a pump that is provided in the decompression passage and causes a pressure of the second gas in the tank to be less than atmospheric pressure by drawing the second gas from the tank, wherein
the valve control unit causes the pump to draw the second gas from the tank by starting the pump when the valve is closed and the intake passage and the tank are disconnected from each other.

3. The suppression system according to claim 2, wherein
when a pressure detected by the sensor after opening the valve becomes equal to or less than a predetermined reference value, the valve control unit closes the valve to disconnect the intake passage and the tank from each other, and starts the pump in a state where the intake passage and the tank are disconnected from each other.

4. The suppression system according to claim 1, comprising:
an internal pressure sensor that is provided in the tank and detects a pressure of the second gas in the tank;
a discharge passage that is connected to the tank to cause communication between the inside of the tank and the outside of the tank; and
a discharge valve that is provided in the discharge passage and switches between communication and disconnection between the inside of the tank and the outside of the tank, wherein
when a pressure detected by the internal pressure sensor is equal to or greater than a predetermined limit value determined according to a pressure resistance value of the tank, the valve control unit releases the discharge valve to cause communication between the inside of the tank and the outside of the tank.

5. The suppression system according to claim 1, comprising:
a supercharger that is provided in the intake passage and pressurizes the intake air, wherein
the threshold value is greater than a pressure increase rate of the intake air by the supercharger.

6. The suppression system according to claim 1, wherein
a volume of the tank is greater than a volume of the intake passage.

7. The suppression system according to claim 1, wherein
the engine includes:
an intake valve that opens when an air-fuel mixture in which combustible gas and the intake air are mixed in the intake passage is taken into the combustion chamber; and
an exhaust valve that opens when exhaust gas after combustion in the combustion chamber is discharged from the combustion chamber, wherein
the intake valve opens before the exhaust valve closes in an exhaust process of discharging exhaust gas in the combustion chamber.

8. The suppression system according to claim 1, wherein
the engine combusts hydrogen or natural gas.

9. The suppression system according to claim 1, further comprising:
a cooling device that is provided in the intake passage and cools the intake air, wherein
the connection passage connects the intake passage and the tank downstream of the cooling device and upstream of the sensor in the intake passage.

10. The suppression system according to claim 9, wherein
the connection passage connects the intake passage and the tank at a position where a distance between the connection passage and the sensor in the intake passage is shorter than a distance between the connection passage and the cooling device.
